(19) United States
(12) Patent Application Publication
(10) Pub. No.: US 2008/0011031 A1
(43) Pub. Date: Jan. 17, 2008

(54) Rack/Lock Apparatus

(76) Inventor: Louis CHUANG, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/761,393

(22) Filed: Jun. 12, 2007

(30) Foreign Application Priority Data
Jul. 14, 2006 (TW) 95125919

(51) Int. Cl. B62H 5/00

(52) U.S. Cl. 70/233

(57) ABSTRACT

A rack/lock apparatus includes a rack and a lock. The rack can be attached to and detached from a bicycle. The lock includes a body and a U-shaped shackle for engagement with the body. The body is attachable to and detachable from the bicycle. The U-shaped shackle can be switched between a locking mode and a supporting mode. In the locking mode, the U-shaped shackle locks the bicycle. In the supporting mode, the U-shaped shackle supports the rack.

### BACKGROUND OF INVENTION

1. Field of Invention

The present invention relates to a rack/lock apparatus.

2. Related Prior Art

A rack/lock apparatus is disclosed in Taiwanese Patent Publication No. 322882. The rack/lock apparatus includes a rack and a lock. The rack includes a backbone, a collar formed on the backbone and two ribs mounted on the backbone. In use, the collar is mounted on a seat tube or seat post of a bicycle. Each of the ribs includes two apertures defined therein. The lock includes a body and a U-shaped shackle. The body of the lock is rotationally installed on the backbone of the rack. When apparatus is not used to lock the bicycle, the U-shaped shackle is inserted through the apertures of the ribs of the rack and engaged with the body of the lock. Thus, the U-shaped shackle is firmly mounted on the rack as reinforcement for the rack. When the apparatus is used to lock the bicycle, the U-shaped shackle is directed across a rear rim of the bicycle and engaged with the body of the lock. There are however problems with this apparatus. Firstly, a saddle has to be detached from the bicycle before the mounting and detachment of the rack. Secondly, a heavy load cannot be exerted on the rack since the rack is only supported on the seat tube or seat post. Thirdly, the lock cannot easily be removed from the rack unless a key is used to release the U-shaped shackle from the body.

The present invention is therefore intended to obviate or at least alleviate the problems encountered in prior art.

### SUMMARY OF INVENTION

According to the present invention, a rack/lock apparatus includes a rack and a lock. The rack can be attached to and detached from a bicycle. The lock includes a body and a U-shaped shackle for engagement with the body. The body of the lock is attachable to and detachable from the bicycle. The U-shaped shackle can be switched between a locking mode for locking the bicycle and a supporting mode for supporting the rack.

An advantage of the rack/lock apparatus according to the present invention is that it can easily attached to and detached from the bicycle.

Another advantage of the rack/lock apparatus according to the present invention is the ability to carry a heavy load since the rack can be supported on the lock.

Another advantage of the rack/lock apparatus according to the present invention is that the lock can easily be removed from the rack.

Other advantages, objectives and features of the present invention will become apparent from the following description referring to the attached drawings.

### BRIEF DESCRIPTION OF DRAWINGS

The present invention will be described via the detailed illustration of three embodiments referring to the drawings.

FIG. 1 is a perspective view of a rack/lock apparatus according to the first embodiment of the present invention.

FIG. 2 is an exploded view of the apparatus shown in FIG. 1.

FIG. 3 is a cross-sectional view of the apparatus shown in FIG. 1.

FIG. 4 is a partial cross-sectional view of the apparatus of FIG. 3.

FIG. 5 is another partial cross-sectional view of the apparatus shown in FIG. 3.

FIG. 6 shows the apparatus in another position shown in FIG. 5.

FIG. 7 shows the apparatus in another position shown in FIG. 6.

FIG. 8 is a side view of a bicycle equipped with the apparatus shown in FIG. 1.

FIG. 9 shows the apparatus shown in another position than shown in FIG. 1.

FIG. 10 is a perspective view of a rack/lock apparatus according to the second embodiment of the present invention.

FIG. 11 is a side view of the apparatus shown in FIG. 10.

FIG. 12 is a cross-sectional of a rack/lock apparatus according to the third embodiment of the present invention.

### DETAILED DESCRIPTION OF EMBODIMENTS

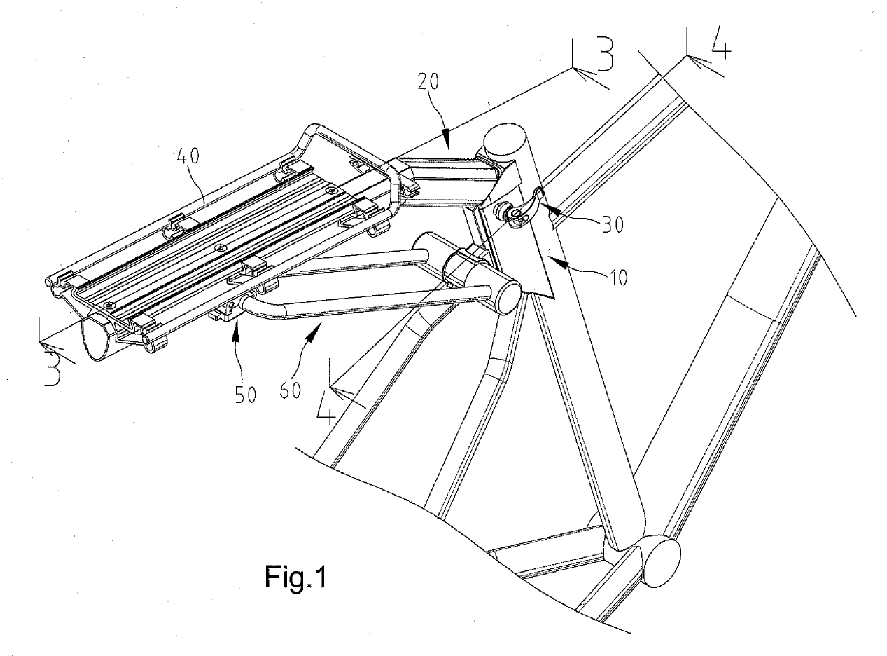

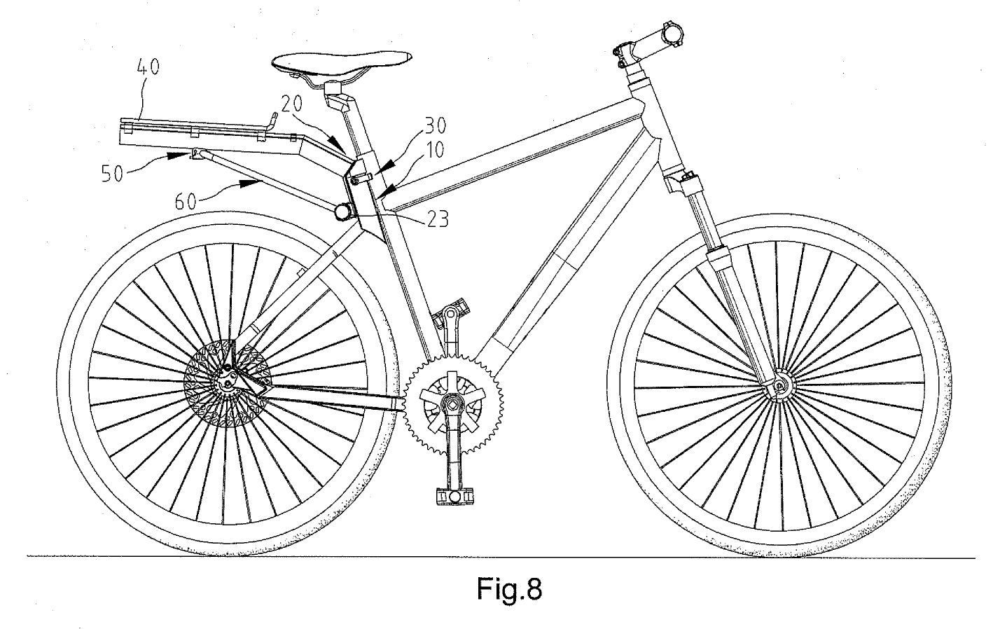

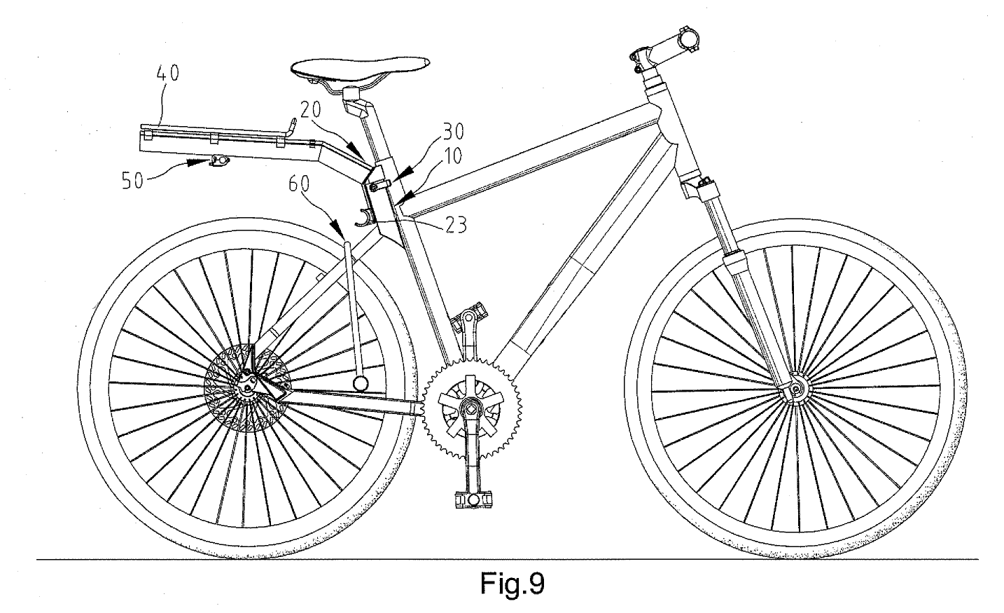

Referring to FIG. 1, a bicycle is equipped with a rack/lock apparatus according to a first embodiment of the present invention. The rack/lock apparatus includes a rack 40 and a lock 60. The lock 60 can be switched between a locking mode referring to FIG. 9 and a supporting mode referring to FIG. 8. In the locking mode, the lock 60 locks the bicycle. In the supporting mode, the lock 60 supports the rack 40. The rack 40 is like any conventional rack and therefore will not be described in detail. The lock 60 includes a body 61 and a U-shaped shackle 62 for engagement with the body 61. The body 61 is formed with a reduced waist 63. The lock 60 is otherwise like any conventional lock and therefore will not be described in detail.

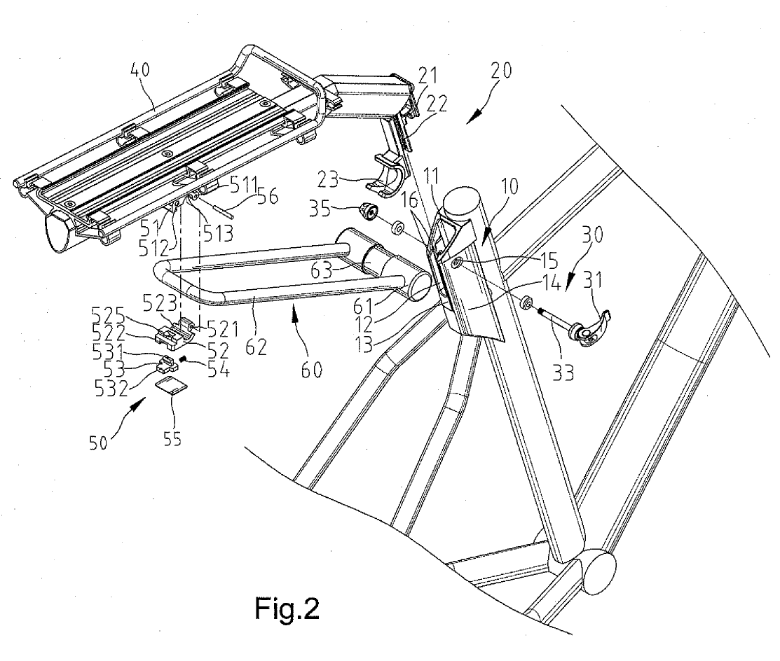

Referring to FIG. 2, an insert 20 is secured to or formed together with the rack 40. The insert 20 includes a cutout 21 defined therein, two opposite grooves 22 defined therein and a claw 23 formed thereon.

A clamp 10 is formed on a seat tube of the bicycle. The clamp 10 includes two jaws 14 and a wall 13 formed between the jaws 14. An aperture 15 is defined in each of the jaws 14. A space 11 is defined between the jaws 14. Each of the jaws 14 is formed with an edge 16. A slot 12 is defined between the edges 16 of the jaws 14.

A quick-release device 30 is provided on the clamp 10. The quick-release device 30 includes a lever/cam element 31, a threaded bolt 33 and a nut 35. The threaded bolt 33 is connected to the lever/cam element 31. The threaded bolt 33 is inserted through the apertures 15. The nut 35 is engaged with the threaded bolt 33. The quick-release device 30 is like any conventional quick-release device 30 and therefore will not be described in detail.

A retaining device 50 is secured to the rack 40. The retaining device 50 includes a first jaw 51, a second jaw 52, a latch 53, an elastic element 54, a plate 55 and a pin 56.

The first jaw 51 is secured to the rack 40. The first jaw 51 includes two ears 511 formed thereon, a teeth 512 formed thereon and a recess 513 defined therein.

The second jaw 52 includes an ear 521 formed thereon, a groove 522 defined in the bottom thereof an opening 525 in communication with the groove 522 and a recess 523 defined therein. The ear 521 is located between the ears 511. The pin 56 is driven in the ears 521 and 511 so that the second jaw 52 is pivotally connected to the first jaw 51.

The latch 53 includes a hook 531 formed thereon and a button 532 formed thereon. The latch 53 is movably disposed in the groove 522. The hook 531 is inserted through the opening 525. The button 532 is extended beyond the second jaw 52.

The elastic element 54 is a helical spring compressed between the latch 53 and the second jaw 52. The plate 55 is secured to the second jaw 52 by adhesion for example, thus retaining the elastic element 54 and the latch 53 connected to the second jaw 52.

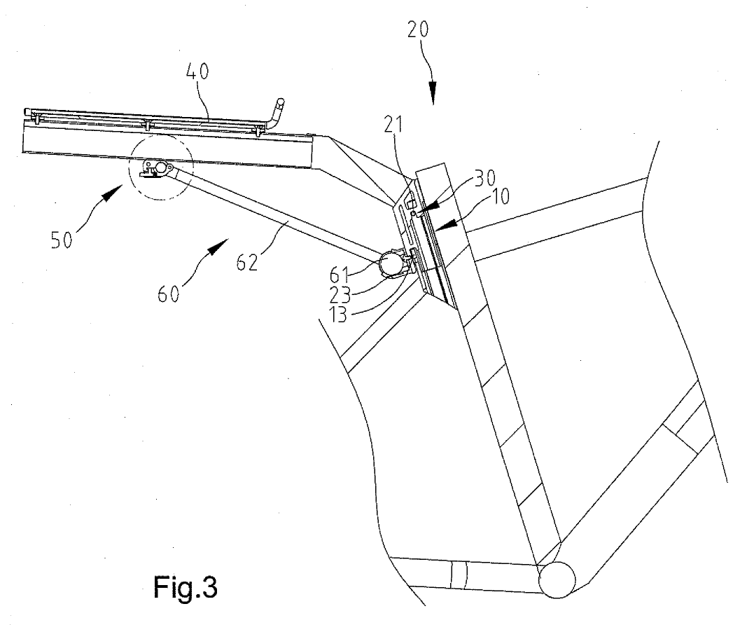

Referring to FIG. 3, the rack 40 and the lock 60 are assembled into a strong structure firmly connected to the seat tube of the bicycle. The insert 20 is clamped by the clamp 10. The waist 63 of the body 61 is held on the claw 23. The U-shaped shackle 62 is held on the retaining device 50.

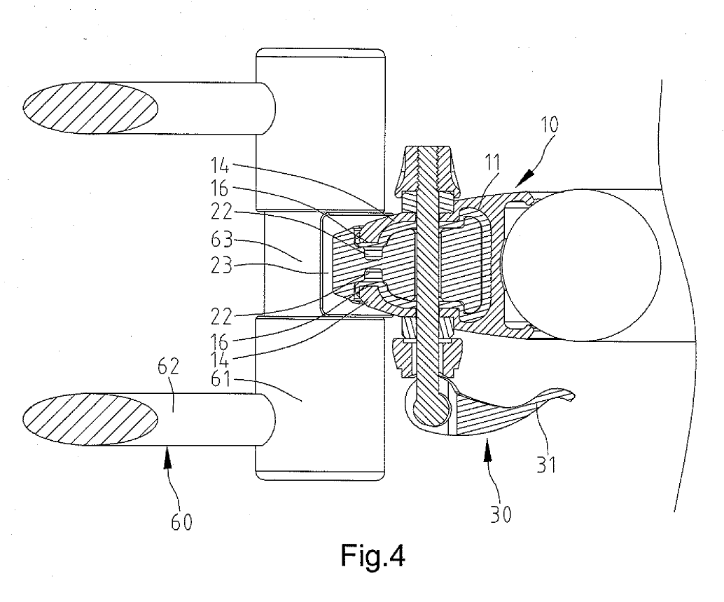

Referring to FIG. 4, the insert 20 is retained on the clamp 10 by the quick-release device 30. The threaded bolt 33 is disposed in the cutout 21. The edges 16 of the jaws 14 are disposed in the grooves 22.

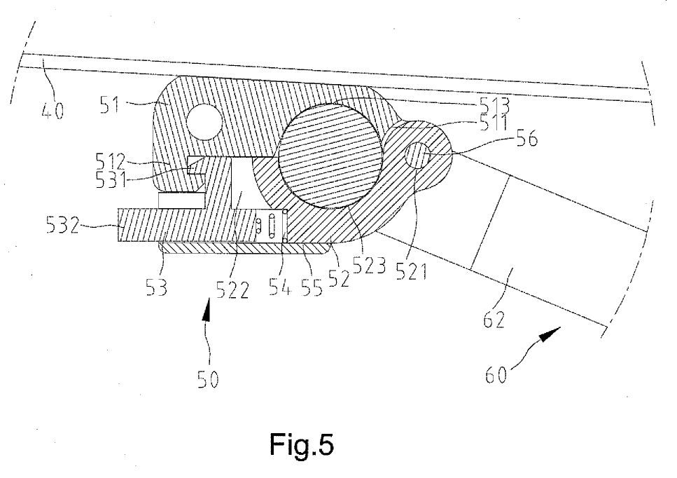

Referring to FIG. 5, the latch 53 is biased by the elastic element 54 so that the hook 531 is engaged with the tooth 512. Thus, the second jaw 52 is locked to the first jaw 51. A portion of the U-shaped shackle 62 is retained between the jaws 51 and 52 and, more particularly, in the recesses 513 and 523.

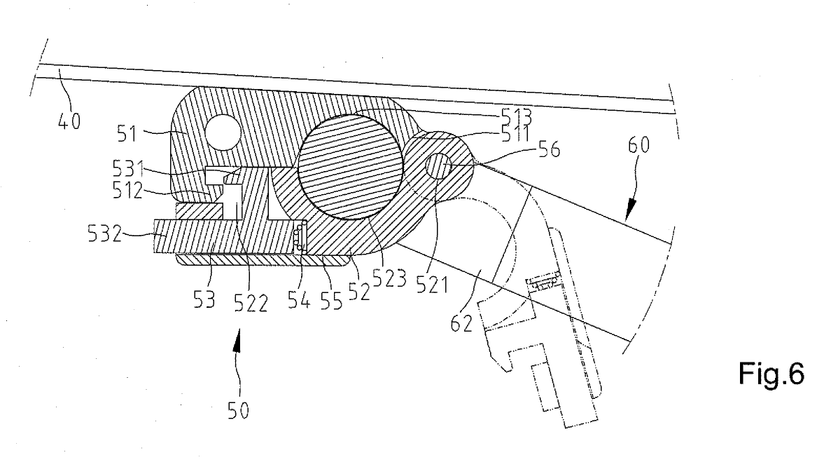

Referring to FIG. 6, the button 532 is pushed so that the elastic element 54 is further compressed and that the latch 53 is moved. Thus, the hook 531 is disengaged from the tooth 512.

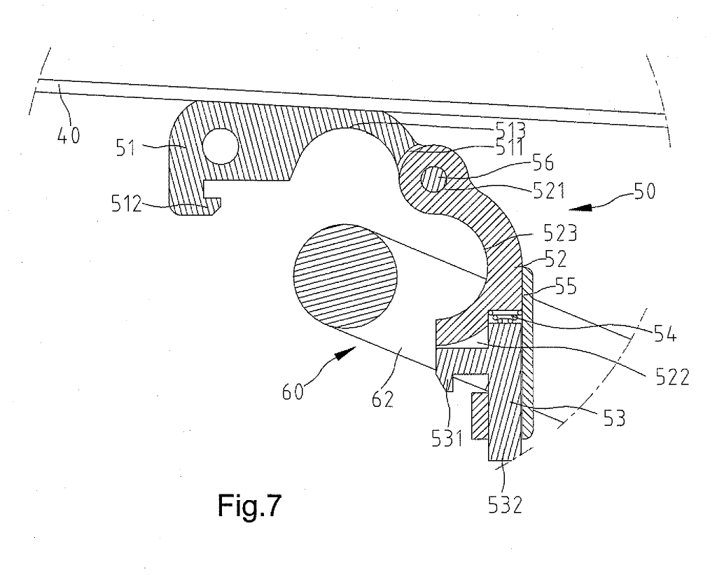

Referring to FIG. 7, the second jaw 52 is pivoted from the first jaw 51, i.e., the retaining device 50 is open. Thus, the U-shaped shackle 62 can be removed from the retaining device 50.

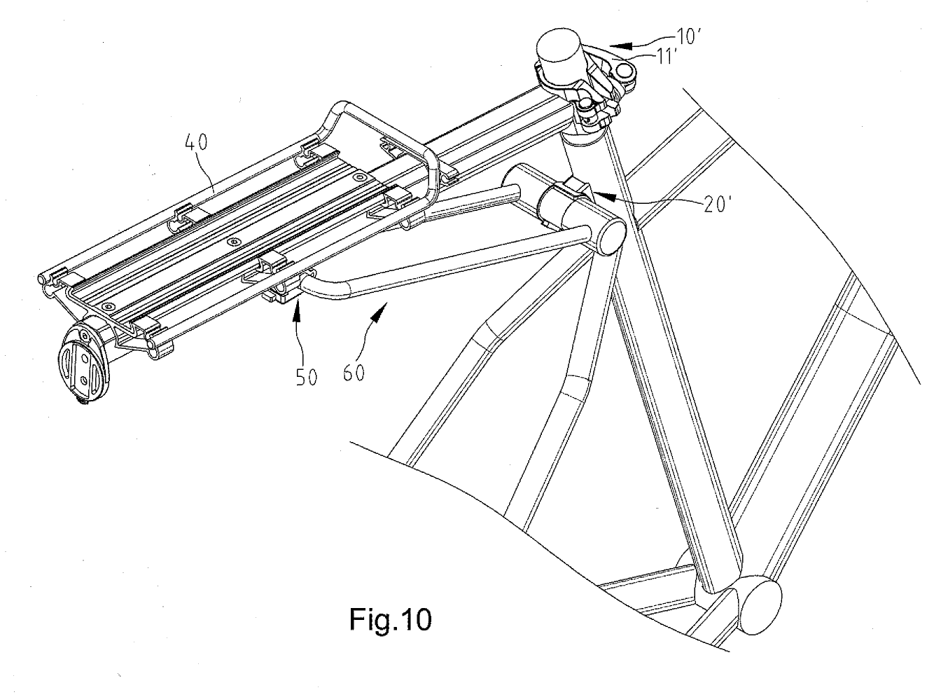

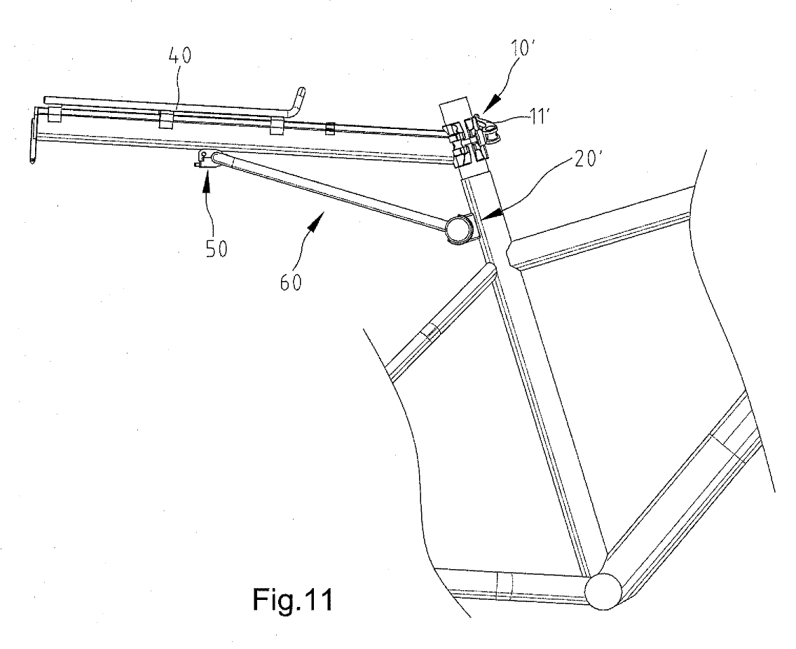

Referring to FIGS. 10 and 11, there is shown a rack/lock apparatus according to a second embodiment of the present invention. The second embodiment is like the first embodiment except a few things. Firstly, the clamp 10 is omitted. Secondly, a clamp 10′ is used instead of the insert 20. The clamp 10′ includes two jaws pivotally connected to each other. The clamp 10′ can be opened to receive a seat post of the bicycle. The clamp 10′ can then be closed to keep the seat post inside. Thirdly, a quick-release element 11′ is provided on the clamp 10′ to keep the clamp 10′ closed.

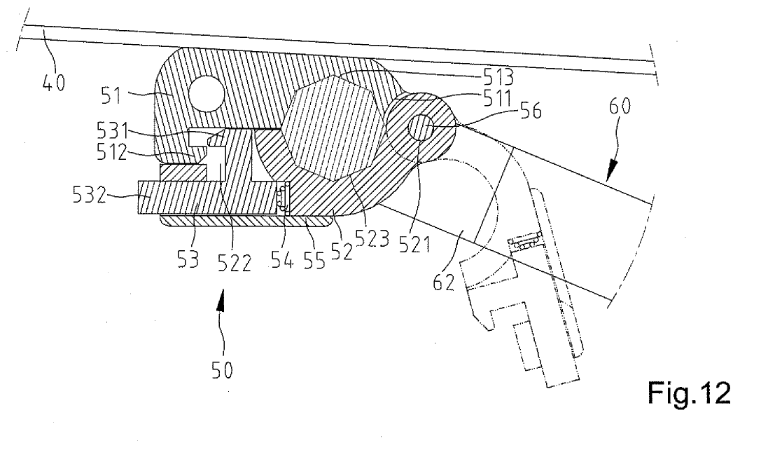

Referring to FIG. 12, there is shown a rack/lock apparatus according to a third embodiment of the present invention. The third embodiment is like the first embodiment except two things. Firstly, the recesses 513 and 523 together form a polygonal aperture. Finally, the U-shaped shackle 62 looks like a polygon in a cross-sectional view. The U-shaped shackle 62 is non-rotationally disposed in the recesses 513 and 523.

The rack/lock apparatus according to the present invention exhibits several advantages. Firstly, the rack/lock apparatus can easily attached to and detached from the seat tube or seat post without having to removing a saddle.

Secondly, a heavy load can be exerted on the rack since the rack is supported on the lock.

Thirdly, the lock can easily be removed from the rack.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A rack/lock apparatus comprising:
a rack attachable to and detachable from a bicycle; and
a lock comprising:
a body attachable to and detachable from the bicycle; and
a U-shaped shackle for engagement with the body, wherein the U-shaped shackle can be switched between a locking mode for locking the bicycle and a supporting mode for supporting the rack.

2. The rack/lock apparatus according to claim 1 comprising a quick-release device for quickly attaching the rack to the bicycle.

3. The rack/lock apparatus according to claim 2 comprising:
a clamp formed on the bicycle, wherein the quick-release device is provided on the clamp; and
an insert extended from the rack and clamped by the clamp.

4. The rack/lock apparatus according to claim 3 wherein the insert comprises two opposite grooves defined therein, and the clamp comprises two jaws each formed with an edge disposed in a related one of the grooves.

5. The rack/lock apparatus according to claim 4 comprising a claw formed on the insert for holding the body of the lock.

6. The rack/lock apparatus according to claim 5 wherein the body of the lock comprises a reduced waist held by the claw.

7. The rack/lock apparatus according to claim 2 comprising a clamp formed on the rack for clamping a portion of the bicycle, wherein the quick-release device is provided on the clamp.

8. The rack/lock apparatus according to claim 7 comprising a retaining device attached to the rack for holding a portion of the U-shaped shackle.

9. The rack/lock apparatus according to claim 8 wherein the retaining device comprises:
a first jaw attached to the rack;
a second jaw pivotally connected to the first jaw; and
a latch movably connected to the second jaw for engagement with the first jaw.

10. The rack/lock apparatus according to claim 9 wherein the U-shaped shackle is non-rotationally clamped by the first and second jaws.

11. The rack/lock apparatus according to claim 10 wherein the retaining device comprises a polygonal aperture defined by the first and second jaws, and the U-shaped shackle comprises a polygonal cross-sectional configuration corresponding to the polygonal aperture.

12. The rack/lock apparatus according to claim 9 wherein the retaining device comprises a pin driven in the first and second jaws.

13. The rack/lock apparatus according to claim 12 wherein the first jaw is formed with at least one ear, and the second jaw is formed with at least one ear, and the pin is driven in the ears.

14. The rack/lock apparatus according to claim 9 wherein the second jaw comprises a groove defined therein for receiving the latch.

15. The rack/lock apparatus according to claim 14 wherein the second jaw comprises an opening in communication with the groove, and the latch comprises a hook inserted through the aperture for engagement with the first jaw.

16. The rack/lock apparatus according to claim 15 wherein the first jaw is formed with a tooth for engagement with the hook.

17. The rack/lock apparatus according to claim 14 wherein the groove is defined in the bottom of the latch.

18. The rack/lock apparatus according to claim 17 wherein the retaining device comprises a plate attached to the second jaw for keeping the latch connected to the second jaw.

19. The rack/lock apparatus according to claim 9 wherein the retaining device comprises an elastic element compressed between the first jaw and the latch.

20. The rack/lock apparatus according to claim 1 wherein the body of the lock is quickly attachable to and detachable from the bicycle.
